(19) United States
(12) Patent Application Publication
(10) Pub. No.: US 2009/0014486 A1
(43) Pub. Date: Jan. 15, 2009

(54) Golf bag motorcycle transport system

(76) Inventor: Johnny Humphreys, Veradale, WA (US)

Correspondence Address: WELLS ST. JOHN P.S., 601 W. FIRST AVENUE, SUITE 1300, SPOKANE, WA, 99201, US

(21) Appl. No.: 11/827,665

(22) Filed: Jul. 12, 2007

(51) Int. Cl. B62J 7/04

(52) U.S. Cl. 224/430; 224/413; 224/419; 224/440; 414/809

(57) ABSTRACT

A golf bag system is provided for transporting a golf bag on a motorcycle, the system including an apparatus and method wherein a first bag side and a second bag side are utilized such that the first bag side is mounted on an opposing side of the motorcycle to the second bag side. When the golf bag is to be utilized to play golf, the golf bag system provides for the operative attachment of the first bag side to the second bag side to become an integral or combined golf bag. The respective golf bag sides include a framework and are mounted rearward of the first rider position on the motorcycle, and may be supported in part by foot pegs that would otherwise be utilized by a passenger on the motorcycle. There are cross supports and other means to attach the respective bag sides to and around the motorcycle and/or to each other for a balanced and comfortable operation of the motorcycle during the transport of the golf bag system.

### CROSS REFERENCE TO RELATED APPLICATION

There are no related applications.

### TECHNICAL FIELD

This invention generally pertains to a golf bag system for transporting a golf bag on a motorcycle, more particularly to such a golf bag system wherein the golf bag is comprised of two sides. In the transport configuration, each of the two sides are mounted on opposing sides of the motorcycle behind the driver, and in the golf configuration are operatively attached together or relative to one another to form an integral golf bag.

### BACKGROUND OF THE INVENTION

There are numerous people who love to play golf and also love to ride motorcycles, and many of those who would like to combine motorcycle riding or touring with playing golf. There has however not yet been an adequate way to transport the clubs that riders perceive as comfortable and relatively easy and that will not seemingly impair handling of the motorcycle.

It is preferred but not required to provide such a golf bag system that would not require, or would minimize, the drilling of holes on the motorcycle. It is also desirable to minimize the time to assemble and disassemble the golf bag when preparing to mount it to a motorcycle and then reassembling it once transport is complete. It is also desirable for embodiments of such invention that the golf bag not unduly interfere with the operation of the motorcycle and that it provide a relatively easy disassembly, transport and assembly of the golf bag system.

It is an object of some embodiments of this invention to provide a golf bag system which includes two sides to a golf bag which may be mounted to opposing sides of a motorcycle behind the rider and which does not unduly interfere with the operation of the motorcycle. Prior systems have taught away from this object and this invention and have not heretofore provided a golf bag motorcycle transport system as desired.

Other objects, features, and advantages of this invention will appear from the specification, claims, and accompanying drawings which form a part hereof. In carrying out the objects of this invention, it is to be understood that its essential features are susceptible to change in design and structural arrangement, with only one practical, and preferred embodiment being illustrated in the accompanying drawings, as required.

### BRIEF DESCRIPTION OF THE DRAWINGS

Preferred embodiments of the invention are described below with reference to the following accompanying drawings:

FIG. 1 is a first side elevation view of one example of an embodiment of a golf bag system mounted to a motorcycle;

FIG. 2 is a second side elevation view of the example of the embodiment of the golf bag system mounted to the opposing side of the motorcycle illustrated in FIG. 1;

FIG. 3 is a perspective view of an embodiment of a golf bag system which may be utilized in practicing this invention;

FIG. 4 is a side elevation view of one side of the embodiment of the golf bag system illustrated in FIG. 3;

FIG. 5 is a perspective view of one embodiment of a framework which may be utilized in embodiments of the golf bag system provided by this invention;

FIG. 6 is a side elevation view of a first side and a second side of the embodiment of the golf bag system illustrated in FIG. 3, joined together for use as a combined golf bag;

FIG. 7 is a cross-sectional three-part figure showing aspects of the embodiment of the invention illustrated in FIG. 4, showing sections represented by Sections 7A, 7B, and 7C;

FIG. 8 is a rear view of an embodiment of the invention wherein the first golf bag side and the second golf bag side are mounted angularly and to among other components, passenger foot pegs on the motorcycle;

FIG. 9 is a front elevation view of a first framework component which may be utilized in practicing the embodiment of this invention illustrated in FIG. 4;

FIG. 10 is a side elevation view of the first framework component illustrated in FIG. 9 wherein the bottom portion is being pivoted to a position that is conforming to a first golf bag side;

FIG. 11 is a side elevation view of the first framework component illustrated in FIG. 9 wherein the bottom portion has been pivoted to a position that approximately conforms to a bottom corner of a first golf bag side, and which is bent approximately ninety degrees (90°) from the main body of the first framework; and

FIG. 12 is a rear view of a system wherein the first golf bag side and the second golf bag side are mounted on rear foot pegs and also to a storage compartment on the motorcycle.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

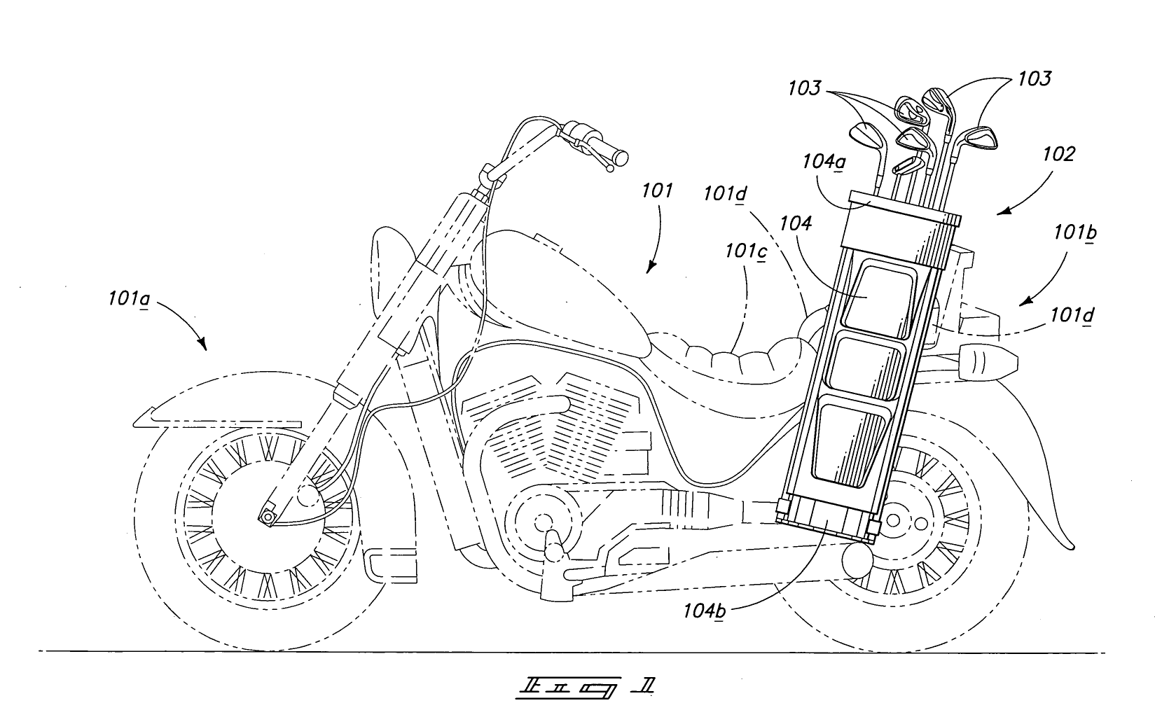

FIG. 1 is a first side elevation view of one example of an embodiment of a golf bag system 102 mounted to a motorcycle 101, with front portion 101a, driver position 101c, passenger position 101d and rear portion 101b. The golf bag system 102 is shown positioned behind the driver position 101c and approximately at or near the passenger position 101d, and although it cannot be seen in this figure, the golf bag system 102 may be mounted on or relative to the foot pegs that a passenger would otherwise utilize.

FIG. 1 further shows golf clubs 103 within first bag side 104, with top portion 104a and bottom portion 104b of first bag side 104. It will be appreciated by those of ordinary skill in the art that although the golf bag system 102 is shown and can be used open or with the golf clubs 103 exposed, it may be preferable to place a golf bag cover over the golf clubs 103 and operatively attach it to the golf bag system 102. It will also be noted by those of ordinary skill in the art that although the golf bag system 102 should be mounted toward the rear portion 101b of the motorcycle 101 and behind the driver position 101c, there are many configurations within the contemplation of this invention and angles and specific positioning that may be utilized to make the golf bag system 102 more comfortable and manageable during the operation of the motorcycle 101 during transport. In the embodiment shown in FIG. 1, the golf bag system 102 is shown mounted at a slight angle rearwardly from the bottom portion 104b to the top portion 104a of the first bag side 104, all within the contemplation of this invention.

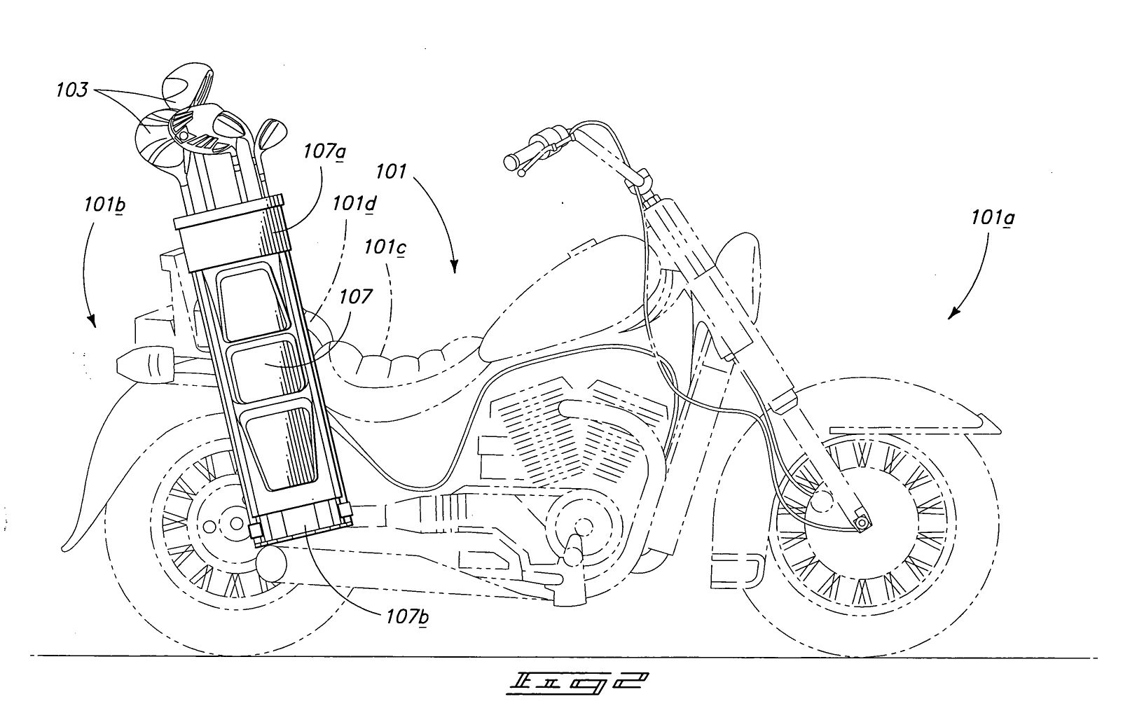

FIG. 2 is a second side elevation view of the example of the embodiment of the golf bag system mounted to the opposing side of the motorcycle 101 illustrated in FIG. 1, showing essentially the same configuration as shown in FIG. 1, only showing the second bag side 107, with top portion 107a and bottom portion 107b. FIG. 2 further illustrates the various motorcycle 101 portions and areas, which are similarly labeled to those described in FIG. 1, and will not be repeated here to avoid repetition.

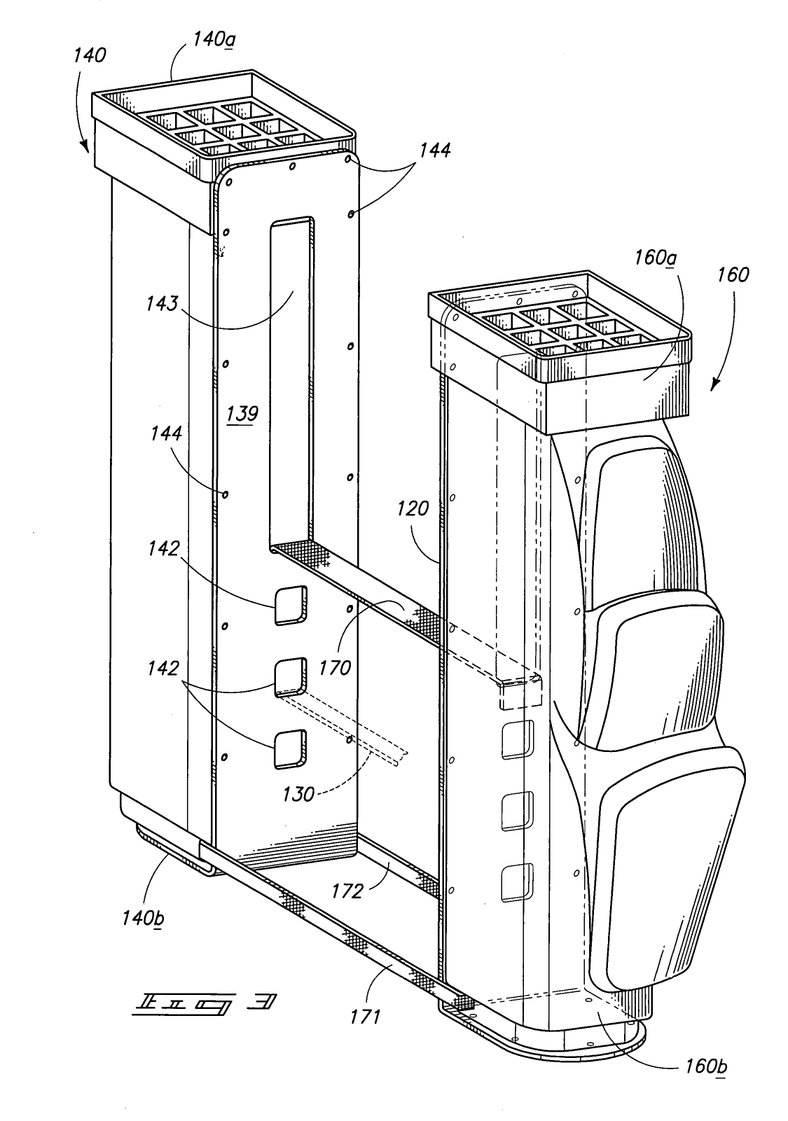

FIG. 3 is a perspective view of an embodiment of a golf bag system 140 which may be utilized in practicing this invention, illustrating first bag side 160 with top portion 160a of first bag side 160 and bottom portion 160b of the first bag side 160. First side framework 120 is shown operatively attached to the first bag side and providing a framework therefore.

FIG. 3 further illustrates second bag side 140 with top portion 140a and bottom portion 140b of second bag side 140. Second bag side 140 is shown operatively attached to second side framework 139 in similar fashion to first bag side 160 being operatively attached or connected to first side framework 120. A plurality of fastener apertures 144 are shown in second side framework 139, provided as one way to attach the framework 120 to the first bag side, along with rider foot peg apertures 142 shown in second side framework 139. Any one of the foot peg apertures 142 or a part thereof, may be the motorcycle supports such that the golf bag side is supported by the foot peg by mounting the foot peg apertures 142 around the foot peg of the motorcycle. The embodiment illustrated in FIG. 3 shows how a plurality of rider peg apertures 142 may be provided to give some flexibility and universality to the golf bag system so that it can be adapted to any one of a number of different motorcycle and rider configurations, with no one in particular being required to practice this invention. An exemplary passenger foot peg 130 is shown relative to the middle foot peg aperture 142 to illustrate its use in supporting the particular embodiments of the golf bag system contemplated by this invention. It should be noted that while motorcycle foot peg apertures are illustrated, other motorcycle supports may be utilized within the contemplation of this invention, such as a foot peg interface or support which would rest on and/or around the motorcycle foot peg although it may not wholly surround it.

FIG. 3 also shows cross support 170 and cross support aperture 143 within second side framework 139. It will be noted that cross support aperture 143 may be elongated in embodiments of this invention to allow greater flexibility in positioning cross support 170 for a specific mount or mount configuration on a given motorcycle. It will be appreciated that the cross support 170 may be any one of a number of different configurations and may interact with or interconnect with the first side framework 120 and/or the second side framework 139, or the first bag side 160 and/or second bag side 140, depending upon the application. It will also be appreciated that cross support 170 may be rigid or it may be flexible or semi-flexible depending upon the specific desired application of the embodiment of the invention and what it is intended to interact with. In one example, cross support 170 may be semi-rigid and located on top of and across the seat portion that a passenger of the motorcycle would otherwise occupy; and in other examples, across some portion of the motorcycle framework or other motorcycle component. The cross support 170 may be moved upward or downward depending upon the location of other components on the motorcycle, such as to better place the foot peg into one of the foot peg apertures, or to facilitate better mounting across a seat portion or a framework portion of the motorcycle to which it will be mounted.

FIG. 3 further illustrates lower cross supports 171, which may be provided on the front and/or the back sides of the first bag side 160 and the second bag side 140, with no particular configuration or number of cross supports 171 being required to practice any particular embodiment of this invention. Although the first bag side 160 and the second bag side 140 are shown relatively parallel to one another, as will be illustrated in a later figure, the operability of the motorcycle may be improved or more desirable if the top portions 160a and 140a respectively are positioned closer to one another than the respective bottom portions 160b and 140b. Angling the respective top portions of the first bag side 160 and second bag side 140 inwardly may provide better aerodynamics and clearances of the motorcycle during transport, as well as having a better aesthetic look.

It will also be appreciated by those of ordinary skill in the art and by prospective motorcycle riders and users of embodiments of this golf bag system, that cross support aperture 143 and the way of interconnecting first side framework 120 and second side framework 139 with cross support 170, provide a very flexible mounting system which can easily be adapted to different configurations on different motorcycles. It may also be preferable in some embodiments of this invention to ascertain the preferred configuration for mounting the golf bag system on one motorcycle and repeating that mount for comfort and predictability in the operation of the motorcycle. It should also be noted that the cross support 170 may be configured in one piece as shown or in more than one piece, all within the contemplation of embodiments of this invention. It may also be preferable in some embodiments of this invention for applications on certain motorcycles that the cross support comprise two pieces, with each configured to attach to one of the golf bag sides and either to the other piece of the cross support or to a motorcycle component.

In an aspect of the invention where the cross support 170 is in multiple pieces, any one of a number of different fasteners may be utilized on the inward ends of the respective cross support pieces to attach each to the other or each to a motorcycle component, all within a contemplation of this invention. For instance a loop with the buckle and opposing hook and loop fasteners such as Velcro may be utilized on each end to connect the respective cross supports, or in any one of a number of different configurations to achieve a secure attachment to the motorcycle or motorcycle component.

In some embodiments of this invention, it may be desirable to provide the first side framework 120 and the second side framework 139 such that they are comprised of a heat resistant material so that heat from the various motorcycle components (engine or tail pipes for example) will not be transmitted into the golf bag or destroy components of the golf bag. In other embodiments, some other bag material such as the fabric or outer later of the bag may be comprised of heat resistant material, or there may be none at all, depending on the specific application and embodiment, all within the scope of this invention. The heat resistant material may be any one of a number of different types of materials, such as metals or alloys, plastics, thermoplastics or others, with no one in particular being required to practice this invention.

It will also be appreciated by those of ordinary skill in the art that in embodiments of this invention the framework may be external to the bag, located within the bag or the framework may further serve as what would traditionally be the material around the bag and providing or defining the internal cavity. For instance if the framework is made of a formed plastic or polymer material shaped to constitute part or all of the bag perimeter, then it would also be considered integral with the bag. It will also be appreciated that the framework may be located within the traditional bag enclosure or internal cavity, all within the scope and contemplation of embodiments of this invention.

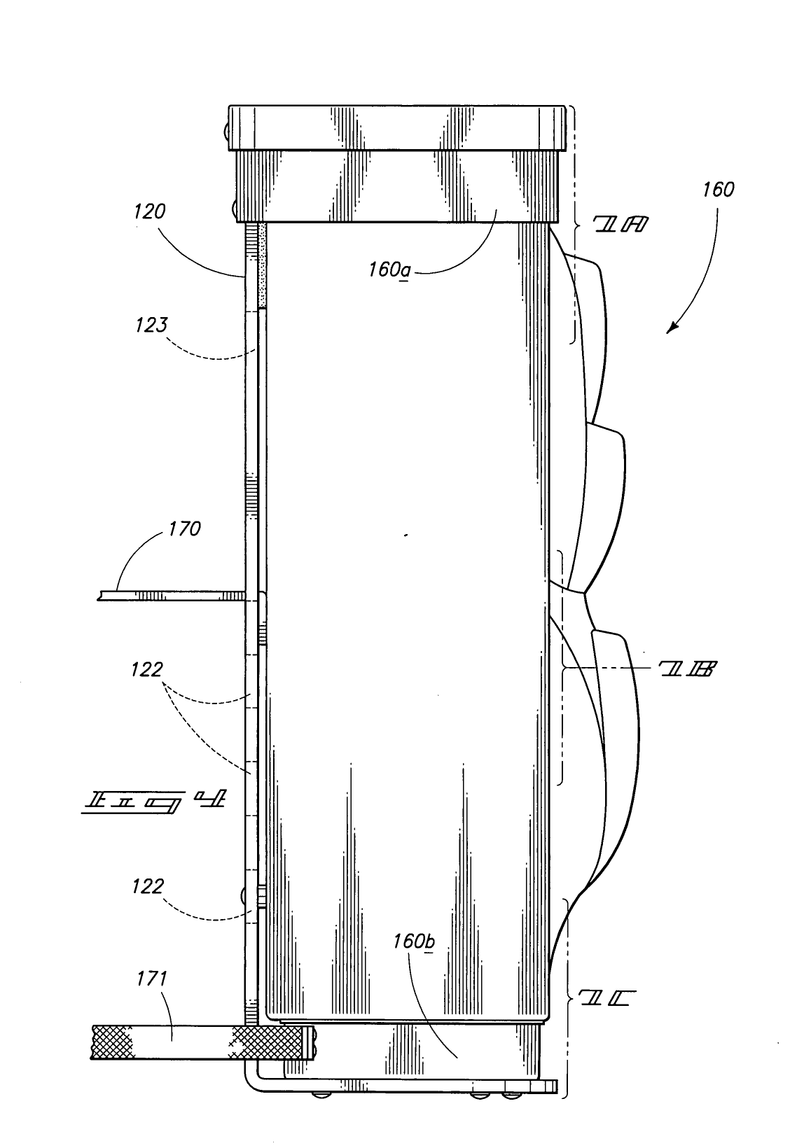

FIG. 4 is a side elevation view of one side of the embodiment of the golf bag system illustrated in FIG. 3, with FIG. 4 illustrating one embodiment on how first side framework 120 may be mounted to first bag side 160, as contemplated by this invention. FIG. 4 illustrates the first side framework 120 with cross support aperture 123 (which corresponds to the cross support aperture 143 in second side framework 139 shown in FIG. 3), a plurality of foot peg apertures 122 within first side framework 120. Cross support 170 is shown as an angle or corner bend protruding through a bottom portion of cross support aperture 123 in the first side framework 120, providing a point on which to secure the angled portion of cross support 170.

FIG. 4 also shows lower cross support 171 attached to lower portion 160b of first bag side 160, and as will be appreciated by those of ordinary skill in the art, lower cross support 171 may be attached to, within or around lower portion 160b in order to secure it during transport and/or to secure it to the second bag side 140 (as shown in FIG. 3) while playing golf. It will also be appreciated by those of ordinary skill in the art that any one of a number of different configurations may be utilized for carrying clubs, including other pockets found in traditional golf bag components, for the first bag side 160 and/or the second bag side 140 (as shown in FIG. 3), with no one particular configuration being required to practice this invention. Any one of a number of different configurations may be utilized to secure and prevent the relative movement of the golf clubs while in the golf bag, and the other items traditionally stored in golf bag pockets, such as golf balls, tees, gloves and the like.

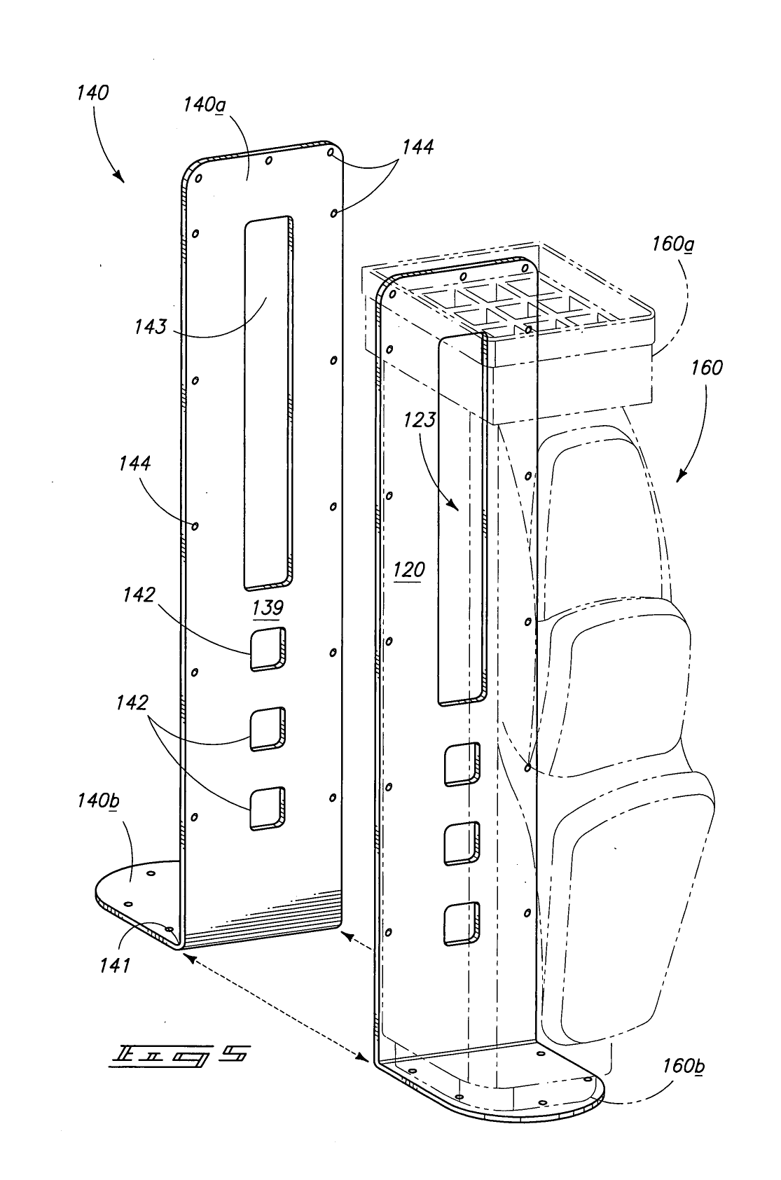

FIG. 5 is a perspective view of one embodiment of a framework which may be utilized in embodiments of the golf bag system provided by this invention, showing the first side framework 120 with first bag side 160 attached thereto. It will be noted that the frameworks may be attached to the respective golf bag sides, or integrated therewith, in any one of a number of different ways. FIG. 5 illustrates rivet holes which may be utilized in combination with fasteners in order to secure the respective golf bag side to the respective framework, with the only requirement being that it be sufficiently secure during transport that the golf bag side will not become disconnected from its respective framework. This invention contemplates that the frameworks may be integral with each bag side, or removable from the bag side, with no one particular configuration being required to practice this invention.

FIG. 5 shows second side framework 139 with passenger foot peg apertures 142, fastener apertures 144, cross support aperture 143, top portion 140a, bottom portion 140b and bend 141. Again, those of ordinary skill in the art can see how the respective sides of the golf bag may be attached together utilizing the framework, the cross support apertures 123 and 143, or any other component of the framework. The respective sides of the golf bag may also be secured together for playing golf by placing a strap partially or wholly around the perimeter of the top portions of the bag sides and/or the middle portion or bottom portions of the golf bag, or in any other way to operably attach the two sides together, with no one particular way being required to practice this invention.

FIG. 6 is a side elevation view of a first side and a second side of the embodiment of the golf bag system illustrated in FIG. 3, joined together for use as a combined golf bag, only wherein the first bag side 160 is operatively connected to second bag side 140 such that the combination provides a unified or integrated golf bag for use playing golf. While it may be preferable for the golf bag to be utilized in connection with a golf cart, the bag can be utilized in a carry fashion by placing any known golf bag strap to the bag in any conventional way. The various components of the first bag side 160 and the second bag side 140 are similarly numbered in FIG. 6 as in FIG. 3 and each item will not therefore repetitiously be identified here, with like numbers representing the same components. FIG. 6 shows top strap 133 extending around the top portions of the respective sides of the bag sides and bottom strap 134 also extending around the bottom portions of the respective sides of the bag, showing one of multiple ways of securing the respective sides of the golf bag together to use as a unified or integrated golf bag to play golf.

It will be appreciated by those of ordinary skill in the art that there are any one of a number of different ways to secure the two sides of the golf bag together for playing golf (flexibly or rigidly), including the attachment of the first side framework to the second side framework instead of placing a strap around the perimeter of a portion of the respective sides of the golf bag.

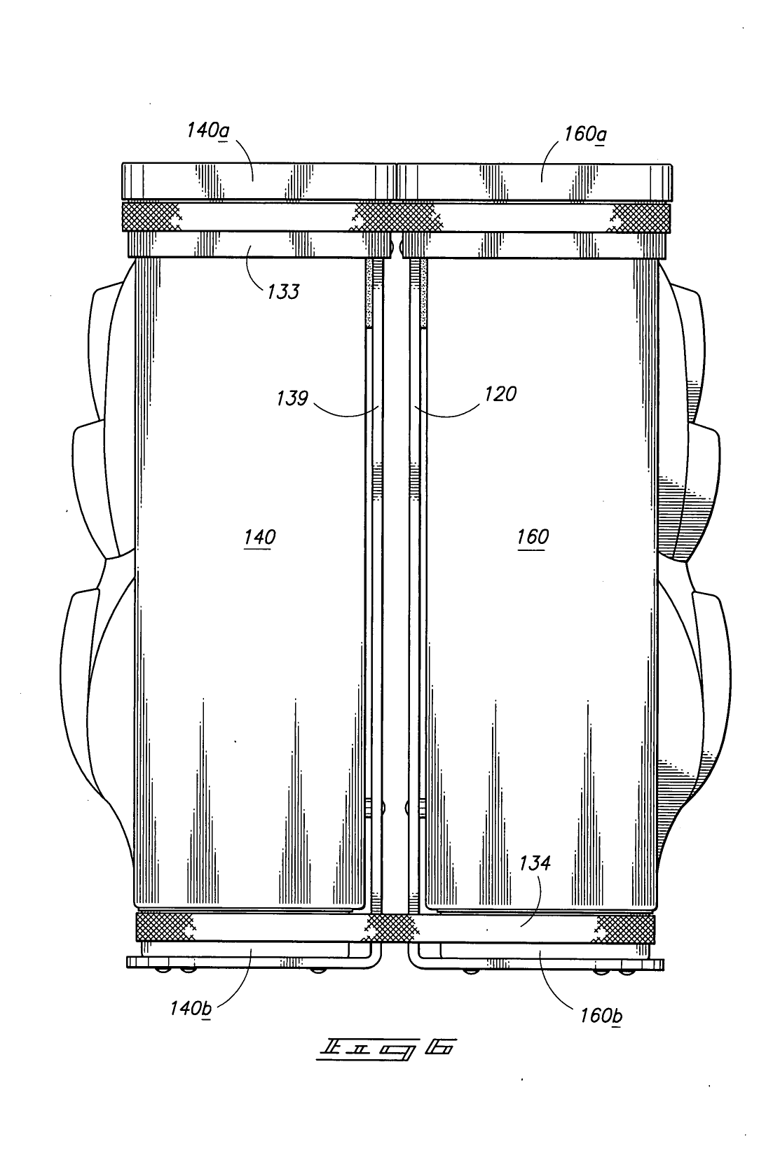

FIG. 7 is a cross-sectional three-part figure showing aspects of the embodiment of the invention illustrated in FIG. 4, showing sections represented by sections 7A, 7B, and 7C. FIG. 7 is comprised of FIG. 7A, FIG. 7B, FIG. 7C, with FIG. 7A being the top portion of the first bag side 160, FIG. 7B being the middle portion of the first bag side 160, and FIG. 7C being the bottom portion of first bag side 160. FIG. 7 illustrates different detail on how to potentially connect first side framework 122 to the bag portion of first bag side 160 and how to interconnect and make interconnections between the respective bag sides during transport and/or during play.

FIG. 7A illustrates top portion 160a of first bag side 160, internal compartments 165, first side framework 120, rivets 178 securing the bag portion to first side framework 120.

FIG. 7B illustrates cross support 170 inserted into cross support aperture 123, internal bag framework 176 and 177, internal compartment 166 within the bag portion of first bag side 160, and foot peg 131 inserted in foot peg aperture 122.

FIG. 7C illustrates internal cavity 166 of the bag portion of first bag side 160, bottom portion 160b, and lower cross support 171 attached to bottom portion 160b securely by fasteners which, in this embodiment, are rivets. Additionally, rivets 178 are shown securing bottom portion 120b to the bottom portion 160b of first bag side 160. Rivet 124 is shown securing bag framework 176 to first side framework 120.

Again, it will be appreciated by those of ordinary skill in the art that no one way in particular is required to practice the embodiment of this invention as far as fastening the various components of the bag portion to the framework portion of the respective golf bag sides, or in fastening interconnection devices and fasteners to the frameworks or the golf bags.

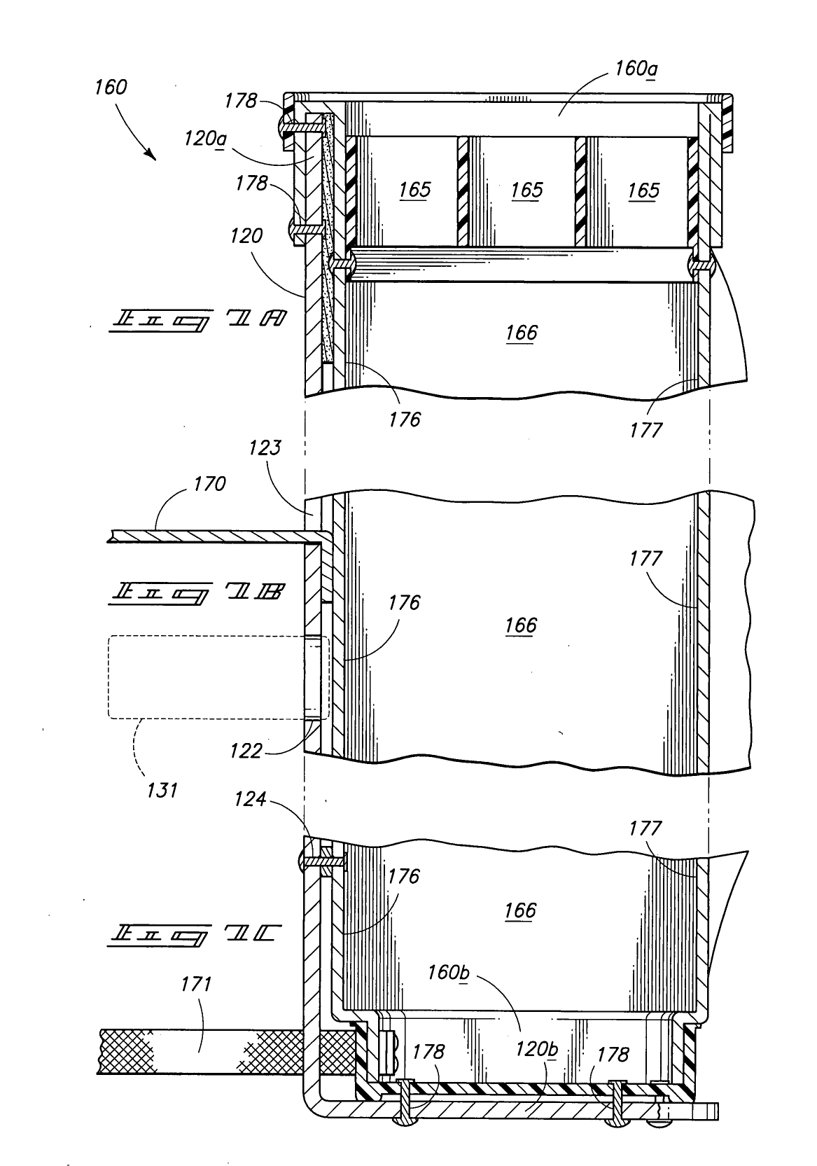

FIG. 8 is a rear view of an embodiment of the invention wherein the first golf bag side 181 and the second golf bag side 183 are mounted angularly and to among other components, passenger foot pegs 182 and 184 on the motorcycle 179. First bag side 181 and second bag side 183 are shown mounted on a rear portion of motorcycle 179, with the golf bag system 180 providing the respective sides at an angle inwardly from bottom to top in order to provide a more aerodynamic configuration.

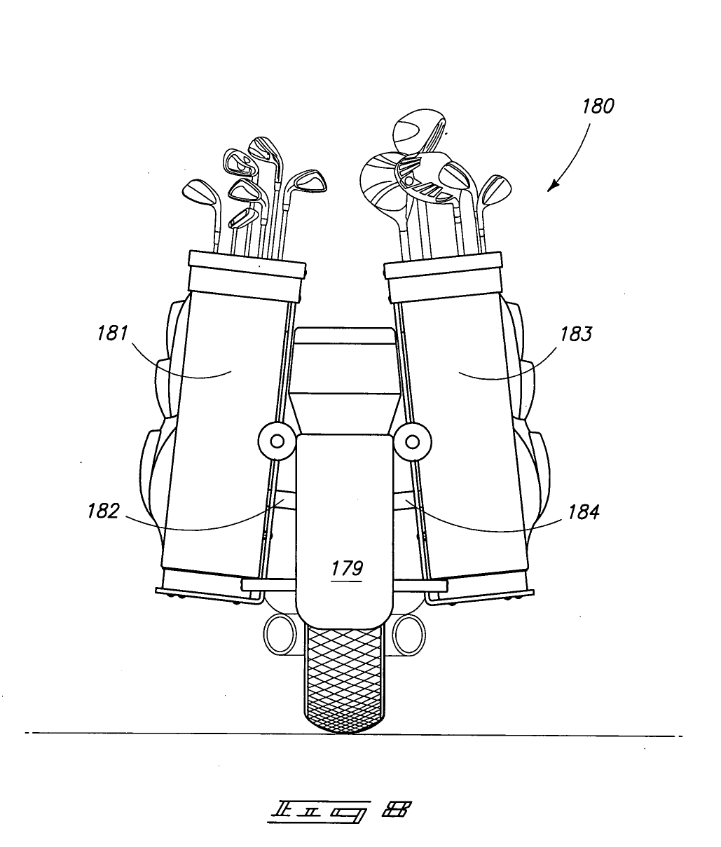

FIG. 9 is a front elevation view of a first side framework 120 component which may be utilized in practicing the embodiment of this invention illustrated in FIG. 4, showing top portion 120a, bottom portion 120b, passenger foot peg apertures 122, with fastener apertures 124, cross support aperture 123, and bend 121. It will be appreciated by those of ordinary skill in the art that any one of a number of different framework configurations may be utilized to practice embodiments of this invention, with no one shape, configuration, number or type of apertures, or other specific requirements necessary to practice embodiments of this invention.

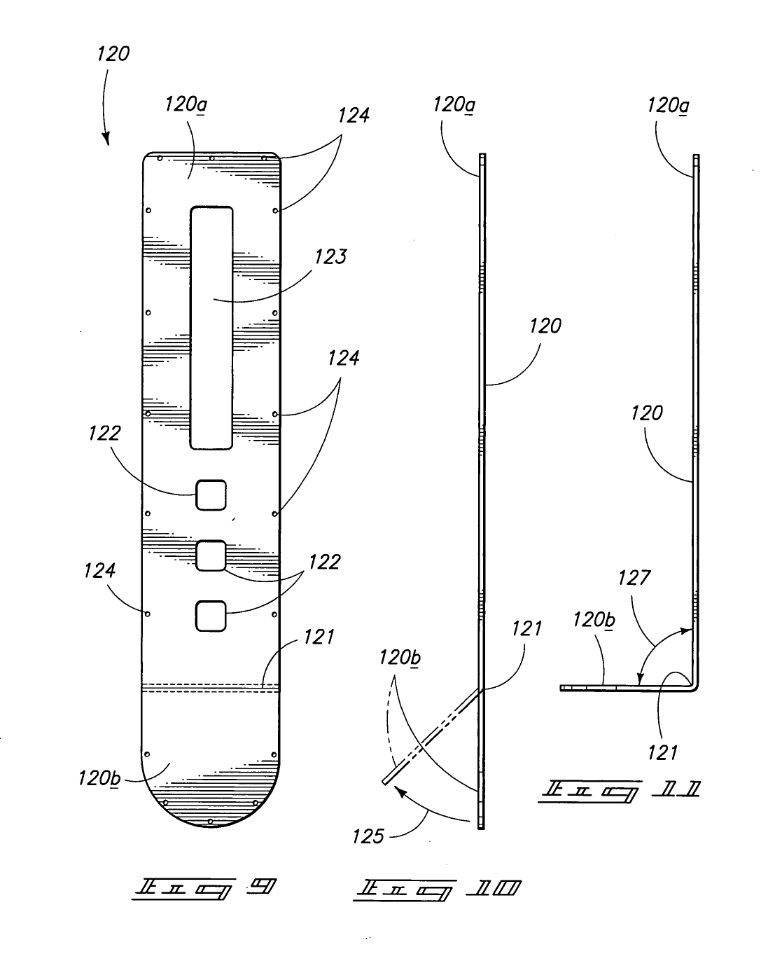

FIG. 10 is a side elevation view of the first side framework 120 illustrated in FIG. 9 wherein the bottom portion 120b is being pivoted to a position that may better conform to a first golf bag side. Arrow 125 illustrates the movement causing bend 121 in order to conform to first side framework 120 to the golf bag portion to which it will be attached.

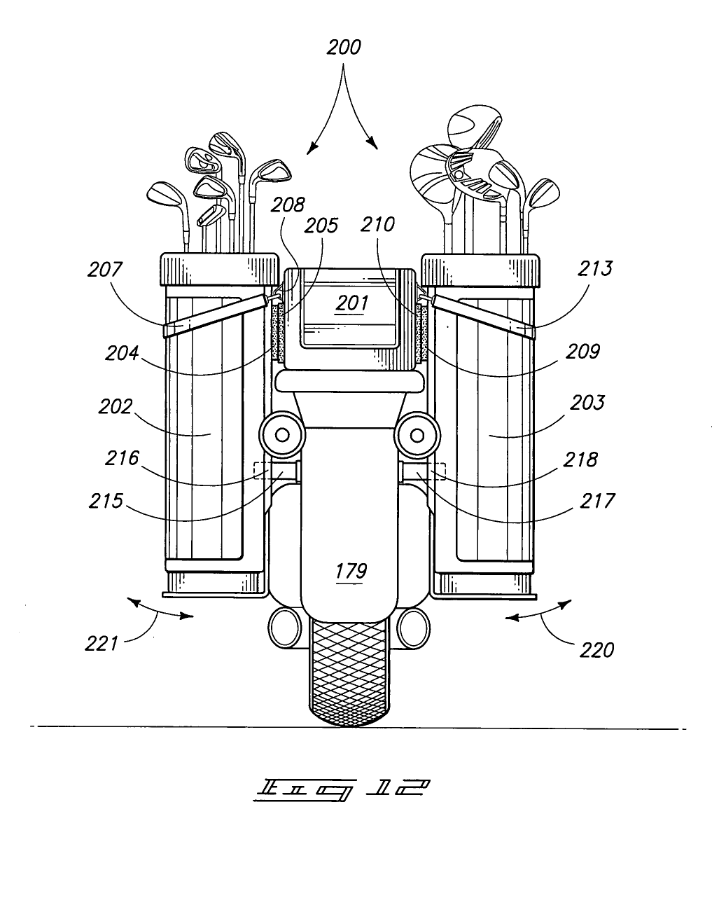

FIG. 11 is a side elevation view of the first side framework 120 illustrated in FIG. 9 wherein the bottom portion 120b has been pivoted to a position that approximately conforms to a bottom corner of a first golf bag side, and which is bent approximately ninety degrees (90°) from the main body of the first side framework 120. Angle 127 shows the angle of the bottom portion 120b relative to the main body and top portion 120a, with the angle being accomplished at bend 121.

FIG. 12 is a rear view of a system wherein the first golf bag side and the second golf bag side are mounted on rear foot pegs and also to a storage compartment on the motorcycle. FIG. 12 illustrate an embodiment of a transport system 200 as contemplated by this invention, showing motorcycle 179 with first bag side 202 and second bag side 203 mounted to motorcycle 179. First bag side 202 is mounted on foot peg 215 via foot peg aperture 216 being placed around foot peg 215. First mount strap 207 is surrounding and retaining or attaching first bag side 202 to motorcycle 179 through being attached to fastener loop 208 which is mounted on compartment 201. Hook and loop fasteners 204 and 205 are provided for additional vertical and lateral fastening. Arrow 221 illustrates how first bag side may be pivoted at a lower or bottom portion to provide aerodynamic effects if the first bag side 202 and the second bag side 203 are angled inwardly at their upper and is behind the motorcycle rider.

Second bag side 203 is similarly mounted and situated on an opposing side of motorcycle 179, with first bag strap 213 securing its upper end, hook and loop fasteners 210 and 209 providing additional fastening as well as vertical and horizontal stability (the hook and loop fasteners may be any one of a number of different types of fasteners, such as those sold under the Velcro brand). Motorcycle foot peg 217 is shown inserted into foot peg aperture 218 in second bag side 203. Arrow 220 shows how second bag side 203 may be angled or pivoted to obtain a desired angle of attachment while in the transport configuration. Compartment 201 not only provides a point, mechanism or means of attachment for both the first bag side 202 and the second bag side 203, but also provides an internal compartment which may be utilized to store other golf components that one may take to a golf course, such as golf cleats and others. Compartment 201 may be attached to a motorcycle and in any one of a number of given ways, depending upon the application and the motorcycle to which it is being attached. For instance it may attach to a luggage rack or any other motorcycle component, with no one in particular being required to practice this invention. Compartment 201 may also be considered as a third bag component and utilized in an integrated way with the first bag side 202 and second bag side 203 while playing golf, and placed together in the rear of a golf cart for instance.

As will be appreciated by those of reasonable skill in the art, there are numerous embodiments to this invention, and variations of elements and components which may be used, all within the scope of this invention.

One embodiment of this invention, for example, is a golf bag motorcycle transport system comprising: a golf bag comprised of a first bag side with a first bag side framework, and a second bag side with a second bag side framework, each bag side including an upper portion, a middle portion and a lower portion, wherein the first bag side and the second bag side are configured to be attached together to constitute an integrated golf bag in a golf configuration; and the first bag side framework and the second bag side framework each include a motorcycle support configured for mounting to a motorcycle component when in a transport configuration; and a cross support attachable and detachable to the first bag side and to the second bag side. There may without limitation be further aspects of this embodiment individually or in any combination, such as: further wherein each of the motorcycle support interfaces are configured for mounting to motorcycle foot pegs; further wherein the first bag side framework and the second bag side framework are integral with the first bag side and the second bag side respectively; further wherein the first bag side framework and the second bag side framework are external to the first bag side and the second bag side respectively, and operatively attachable thereto; further wherein the cross support is configured to be supported by a motorcycle component; further wherein the first bag side framework and the second bag side framework are at least partially comprised of heat resistant material; further wherein the motorcycle supports are motorcycle foot peg apertures; further wherein the motorcycle supports are motorcycle foot peg interfaces; further wherein the first bag side and second bag side are configured to mount to opposing sides of a motorcycle such that the upper portion of the first and second bag sides are angled inwardly relative to the lower portions; and/or further wherein the cross support is one piece.

In a method embodiment, a method of transporting a golf bag on a motorcycle may be provided which comprises: providing a golf bag comprised of a first bag side with a first bag side framework, and a second bag side with a second bag side framework; mounting the first bag side framework to a first side of a motorcycle and mounting the second bag side framework to a second side of the motorcycle, such that both the first bag side framework and the second bag side framework are fixedly disposed on opposing sides of the motorcycle and each are configured to be supported by a motorcycle component; dismounting the first bag side and the second bag side from the motorcycle; and operatively attaching the first bag side to the second bag side to form an integrated golf bag for play. There may without limitation be further aspects of this embodiment individually or in any combination, such as: further wherein the first bag side and the second bag side include a foot peg aperture configured to receive support from a foot peg on the motorcycle to which it is mounted; and/or further wherein the first bag side and the second bag side are fixedly disposed by a cross support secured to both the first bag side and the second bag side at one of the respective top portions and the middle portions of the first bag side and the second bag side.

In a further embodiment, a motorcycle based golf bag transport system is provided, comprised of: a motorcycle with a driver's seat, a golf bag comprised of a first bag side with a first bag side framework, and a second bag side with a second bag side framework, wherein the first bag side framework is removably mounted to a first side of the motorcycle and the second bag side framework is mounted to a second side of the motorcycle. There may without limitation be further aspects of this embodiment individually or in any combination, such as: further wherein top portions of the first bag side and the second bag side are mounted angularly inwardly; and/or further wherein top portions of the first bag side and the second bag side are operatively attached to each other.

In yet a further embodiment, a motorcycle based golf bag transport system may be provided which comprises: a motorcycle with a driver's seat and first and a second passenger foot pegs mounted on opposing sides of the motorcycle behind the driver's seat; a golf bag comprised of a first bag side with a first bag side framework, and a second bag side with a second bag side framework, wherein the first bag side framework is removably mounted to a first side of the motorcycle on the first passenger foot peg and the second bag side framework is mounted to a second side of the motorcycle on the second passenger foot peg; the first bag side is operatively attached to the second bag side at one of an upper portion and a middle portion; and wherein the top portions of the first bag side and the second bag side are mounted angularly inwardly.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. A golf bag motorcycle transport system comprising:
a golf bag comprised of a first bag side with a first bag side framework, and a second bag side with a second bag side framework, each bag side including an upper portion, a middle portion and a lower portion, wherein;
the first bag side and the second bag side are configured to be attached together to constitute an integrated golf bag in a golf configuration; and
the first bag side framework and the second bag side framework each include a motorcycle support configured for mounting to a motorcycle component when in a transport configuration; and
a cross support attachable and detachable to the first bag side and to the second bag side.

2. A golf bag motorcycle transport system as recited in claim 1, and further wherein each of the motorcycle support interfaces are configured for mounting to motorcycle foot pegs.

3. A golf bag motorcycle transport system as recited in claim 1, and further wherein the first bag side framework and the second bag side framework are integral with the first bag side and the second bag side respectively.

4. A golf bag motorcycle transport system as recited in claim 1, and further wherein the first bag side framework and the second bag side framework are external to the first bag side and the second bag side respectively, and operatively attachable thereto.

5. A golf bag motorcycle transport system as recited in claim 1, and further wherein the cross support is configured to be supported by a motorcycle component.

6. A golf bag motorcycle transport system as recited in claim 1, and further wherein the first bag side framework and the second bag side framework are at least partially comprised of heat resistant material.

7. A golf bag motorcycle transport system as recited in claim 1, and further wherein the motorcycle supports are motorcycle foot peg apertures.

8. A golf bag motorcycle transport system as recited in claim 1, and further wherein the motorcycle supports are motorcycle foot peg interfaces.

9. A golf bag motorcycle transport system as recited in claim 1 and further wherein the first bag side and second bag side are configured to mount to opposing sides of a motorcycle such that the upper portion of the first and second bag sides are angled inwardly relative to the lower portions.

10. A golf bag motorcycle transport system as recited in claim 1 and further wherein the cross support is one piece.

11. A method of transporting a golf bag on a motorcycle, comprising:
providing a golf bag comprised of a first bag side with a first bag side framework, and a second bag side with a second bag side framework;
mounting the first bag side framework to a first side of a motorcycle and mounting the second bag side framework to a second side of the motorcycle, such that both the first bag side framework and the second bag side framework are fixedly disposed on opposing sides of the motorcycle and each are configured to be supported by a motorcycle component; dismounting the first bag side and the second bag side from the motorcycle; and
operatively attaching the first bag side to the second bag side to form an integrated golf bag for play.

12. A method of transporting a golf bag on a motorcycle as recited in claim 11, and further wherein the first bag side and the second bag side include a foot peg aperture configured to receive support from a foot peg on the motorcycle to which it is mounted.

13. A method of transporting a golf bag on a motorcycle as recited in claim 11, and further wherein the first bag side and the second bag side are fixedly disposed by a cross support secured to both the first bag side and the second bag side at one of the respective top portions and the middle portions of the first bag side and the second bag side.

14. A motorcycle based golf bag transport system comprising:
a motorcycle with a driver's seat,
a golf bag comprised of a first bag side with a first bag side framework, and a second bag side with a second bag side framework, wherein;
the first bag side framework is removably mounted to a first side of the motorcycle and the second bag side framework is mounted to a second side of the motorcycle.

15. A motorcycle based golf bag transport system as recited in claim 14, and further wherein top portions of the first bag side and the second bag side are mounted angularly inwardly.

16. A motorcycle based golf bag transport system as recited in claim 14, and further wherein top portions of the first bag side and the second bag side are operatively attached to each other.

17. A motorcycle based golf bag transport system comprising: p1 a motorcycle with a driver's seat and first and a second passenger foot pegs mounted on opposing sides of the motorcycle behind the driver's seat;
a golf bag comprised of a first bag side with a first bag side framework, and a second bag side with a second bag side framework, wherein;
the first bag side framework is removably mounted to a first side of the motorcycle on the first passenger foot peg and the second bag side framework is mounted to a second side of the motorcycle on the second passenger foot peg;
the first bag side is operatively attached to the second bag side at one of an upper portion and a middle portion;
wherein the top portions of the first bag side and the second bag side are mounted angularly inwardly.
